(19) United States
(12) Patent Application Publication
(10) Pub. No.: US 2013/0100900 A1
(43) Pub. Date: Apr. 25, 2013

(54) DATA TRANSCEIVING METHOD AND MACHINE TYPE COMMUNICATION DEVICE USING THE SAME

(71) Applicant: Electronics and Telecommunications Research In, Daejeon (KR)

(72) Inventors: Moon Sik LEE, Daejeon (KR); Jun Hwan LEE, Seoul (KR); Young Seog SONG, Daejeon (KR); Il Gyu KIM, Chungbuk (KR)

(73) Assignee: Electronics and Telecommunications Research Institute, Daejeon (KR)

(21) Appl. No.: 13/654,963

(22) Filed: Oct. 18, 2012

(30) Foreign Application Priority Data
Oct. 21, 2011 (KR) 10-2011-0108264
Oct. 24, 2011 (KR) 10-2011-0108547
Jul. 31, 2012 (KR) 10-2012-0083791

(51) Int. Cl. H04W 72/04

(52) U.S. Cl. 370/329

(57) ABSTRACT

Disclosed are a data transmission and reception method and a machine type communication (MTC) device using the same. The data transmission and reception method according to the present invention may include: extracting MTC bandwidth information through a downlink channel or signaling; receiving the downlink channel or signaling including MTC downlink control format information; detecting resource region information occupied by the MTC downlink control channel; and receiving the MTC downlink control channel using the resource region information occupied by the MTC downlink control channel.

### CLAIM FOR PRIORITY

This application claims priority to Korean Patent Application No. 10-2011-0108264 filed on Oct. 21, 2011, Korean Patent Application No. 10-2011-0108547 filed on Oct. 24, 2011, and Korean Patent Application No. 10-2012-0083791 filed on Jul. 31, 2012 in the Korean Intellectual Property Office (KIPO), the entire contents of which are hereby incorporated by reference.

### BACKGROUND

1. Technical Field

Example embodiments of the present invention relate in general to a data transmission and reception method and a machine type communication (MTC) device using the same, and more specifically, to a method of transmitting and receiving data between a base station and an MTC device for supporting MTC.

2. Related Art

Machine type communication (MTC) and machine to machine communication (M2M) are each a form of data communication which involves one or more entities that do not necessarily need human interaction. A service optimized for machine type communications differs from a service optimized for human to human communications. Machine type communication is different from current mobile network communication services as it involves: a) different market scenarios, b) data communication, c) lower costs and effort, d) a potentially very large number of communicating terminals, with, e) a large extent, and f) little traffic per terminal.

MTC may be implemented in various forms of service, and its representative applications include smart metering, tracking & tracing, remote maintenance & control, eHealth, and so on.

M2M has been standardized in 3rd generation partnership project (3GPP) with a separate term “MTC”. Up to date, MTC standardization in upper layers has been discussed. Lately, MTC standardization in physical layers is being discussed. Standardization for low-priced MTC devices is expected to be performed in earnest in the next standardization meeting.

Legacy LTE user terminals are defined to support transmission and reception bandwidth of up to 20 MHz in the specifications in Rel-8, Rel-9, and Rel-10. Accordingly, legacy LTE user terminals can access a base station (eNodeB) having a bandwidth of 1.4 MHz, 3 MHz, 5 MHz, 10 MHz, 15 MHz, or 20 MHz. However, MTC devices transmit and receive a very small amount of data. Thus, if MTC devices, which are aimed at low cost, support a bandwidth of 20 MHz, it may cause significant losses in terms of power consumption and cost.

### SUMMARY

Accordingly, example embodiments of the present invention are provided to substantially obviate one or more problems due to limitations and disadvantages of the related art.

Example embodiments of the present invention provide a data transmission and reception method of a low-priced MTC device having a narrow bandwidth in an LTE based system supporting a scalable transmission and reception bandwidth.

Example embodiments of the present invention also provide a machine type communication (MTC) device using the data transmission and reception method.

Example embodiments of the present invention also provide a downlink data transmission method of a base station for the machine type communication (MTC) device.

Example embodiments of the present invention also provide a base station using the downlink data transmission method.

In some example embodiments, a data transmission and reception method includes: extracting MTC bandwidth information through a downlink channel or signaling; receiving the downlink channel or signaling including MTC downlink control format information; detecting resource region information occupied by the MTC downlink control channel; and receiving the MTC downlink control channel using the resource region information occupied by the MTC downlink control channel.

The resource region occupied by the MTC downlink control channel may be positioned in the center of an entire system band on a frequency axis.

The method may further include demodulating an MTC downlink data channel using the MTC downlink control channel.

The downlink channel including MTC downlink control format information may further include downlink control format information for a user terminal.

The MTC downlink control channel and the MTC downlink data channel may be divided by frequency division multiplexing or time division multiplexing.

The MTC downlink control channel and the MTC downlink data channel may be included in a downlink data region for a user terminal.

The downlink channel including MTC downlink control format information may be positioned in a first time region or a last time region of a downlink resource region for the MTC device, or in a top frequency region of the downlink resource region of the MTC device.

The signaling including the MTC downlink control format information may be radio resource control (RRC) signaling or layer 1 (L1) signaling.

The method may further include extracting control information for MTC uplink data transmission, and transmitting MTC uplink data using an MTC uplink data channel and optionally an MTC uplink control channel when the MTC downlink control channel includes the control information for MTC uplink data transmission.

The MTC uplink control channel or the MTC uplink data channel may be positioned within a downlink data region for a user terminal.

The MTC uplink data channel and the MTC uplink control channel may be divided by frequency division multiplexing.

The MTC uplink data channel and the MTC uplink control channel may occupy a top frequency region and a bottom frequency region of a bandwidth for the MTC device.

In other example embodiments, a machine type communication (MTC) device includes: a reception unit receiving at least one downlink channel or signaling; a control unit detecting MTC bandwidth information and an MTC downlink control channel through the received downlink channel or signaling, demodulating an MTC downlink data channel using the MTC downlink control channel, and extracting control information for MTC uplink data transmission; and a transmission unit transmitting uplink data on the basis of the control information for the MTC uplink data transmission.

The resource region occupied by the MTC downlink control channel may be positioned in the center of an entire system band on a frequency axis.

The MTC downlink control channel and the MTC downlink data channel may be divided by frequency division multiplexing or time division multiplexing.

In still other example embodiments, a method of transmitting downlink data includes: determining whether resource allocated for a machine type communication (MTC) device is included in a given resource period; configuring a downlink frame according to information about a resource region for the MTC device and bandwidth for the MTC device; and transmitting the configured downlink frame to at least one MTC device.

The resource for the MTC device may include a control channel and data channel for the MTC device and optionally an indicator for the control channel, and a resource region occupied by an MTC downlink control channel may be positioned in the center of an entire system band on a frequency axis.

In still other example embodiments, a base station includes: a machine type communication (MTC) resource information storage unit storing a bandwidth for MTC, information about a control channel and a data channel, and an indicator for the control channel; and a frame configuration unit determining whether resource allocated for the MTC device is included in a given resource period and configuring a downlink frame according to the bandwidth for the MTC device and information about a resource region for the MTC device.

### BRIEF DESCRIPTION OF DRAWINGS

Example embodiments of the present invention will become more apparent by describing in detail example embodiments of the present invention with reference to the accompanying drawings, in which:

FIG. 1 is a concept view illustrating a mobile communication network for providing MTC service applying the present invention;

FIGS. 2 to 4 illustrate methods of allocating a downlink control channel and a data channel according to embodiments of the present invention;

FIGS. 5 and 6 illustrate MTC-PDCCH indication for MTC-PDSCH demodulation using a method of allocating a physical channel according to an embodiment of the present invention as shown in FIG. 2;

FIGS. 7 and 8 illustrate MTC-PDCCH indication for MTC-PDSCH demodulation using a method of allocating a physical channel according to an embodiment of the present invention as shown in FIG. 3;

FIGS. 9 and 10 illustrate MTC-PDCCH indication for MTC-PDSCH demodulation using a method of allocating a physical channel according to an embodiment of the present invention as shown in FIG. 4;

FIG. 11 is a concept view illustrating resource allocation in an MTC uplink according to an embodiment of the present invention;

FIG. 12 is a concept view illustrating resource allocation in an MTC uplink according to another embodiment of the present invention;

FIG. 13 is a flowchart illustrating a method of transmitting and receiving data between a base station and a general legacy LTE terminal;

FIG. 14 is a flowchart illustrating a method of transmitting and receiving data between a base station and an MTC device according to an embodiment of the present invention;

FIG. 15 is a block diagram showing an MTC device according to an embodiment of the present invention;

FIG. 16 is a flowchart illustrating a method of allocating resource according to an exemplary embodiment of the present invention; and

FIG. 17 is a block diagram showing a base station according to an embodiment of the present invention.

### DESCRIPTION OF EXAMPLE EMBODIMENTS

Example embodiments of the present invention are described below in sufficient detail to enable those of ordinary skill in the art to embody and practice the present invention. It is important to understand that the present invention may be embodied in many alternate forms and should not be construed as limited to the example embodiments set forth herein.

Accordingly, while the invention can be modified in various ways and take on various alternative forms, specific embodiments thereof are shown in the drawings and described in detail below as examples. There is no intent to limit the invention to the particular forms disclosed. On the contrary, the invention is to cover all modifications, equivalents, and alternatives falling within the spirit and scope of the appended claims. Elements of the example embodiments are consistently denoted by the same reference numerals throughout the drawings and detailed description.

The terminology used herein to describe embodiments of the invention is not intended to limit the scope of the invention. The articles “a,” “an,” and “the” are singular in that they have a single referent, however the use of the singular form in the present document should not preclude the presence of more than one referent. In other words, elements of the invention referred to in the singular may number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art to which this invention belongs. It will be further understood that terms in common usage should also be interpreted as is customary in the relevant art and not in an idealized or overly formal sense unless expressly so defined herein.

A terminal used in the specification may be referred to as a mobile station (MS), user equipment (UE), a user terminal (UT), a wireless terminal, an access terminal (AT), a terminal, a subscriber unit, a subscriber station (SS), a wireless device, a wireless communication device, a wireless transmit/receive unit (WTRU), a mobile node, a mobile, or the other terms. Various embodiments of the terminal may include a cellular phone, a smart phone having a wireless communication function, a personal digital assistant (PDA) having a wireless communication function, a wireless modem, a portable computer having a wireless communication function, a capturing device such as a digital camera having wireless communication function, a game device having a wireless communication function, a music storage and replay appliance having a wireless communication function, an Internet appliance enabling wireless Internet access and browsing, and terminals or a portable unit having combinations of the functions, but the present invention is not limited thereto.

To separate the concept of the terminal in this specification from that of the terminal mainly used by users, a terminal used for an MTC service is referred to as a “MTC device”, and a terminal used for a general and traditional communication between users, except for the MTC service, is referred to as a “user terminal”. Also, the term “machine type communication device” may be used as a comprehensive term including several terms used in an organization for standardization, etc. such as an MTC terminal/device, an M2M terminal/device, and so on.

Here, the user terminal supports long term evolution (LTE) and/or LTE-Advanced defined in 3GPP specification Rel-8, Rel-9, and Rel-10, which may be referred to as a legacy LTE terminal.

A base station used in the specification is generally a fixed part for communicating with terminals, and may be a term that indicates the collective name for a node-B, an eNode-B, a base transceiver system, an access point, etc.

Hereinafter, example embodiments of the present invention will be described in detail with reference to the accompanying drawings. In describing the invention, to facilitate overall understanding of the invention, like numbers refer to like elements throughout the description of the figures, and a repetitive description on the same element is not provided.

To solve a problem where an excessive bandwidth is supported to the low-priced MTC device, a method of supporting only a narrow bandwidth such as 1.4 MHz, 5 MHz, or the like, is used for the MTC device.

For this end, a separate wireless transmission specification is required to support communication between the MTC device with a narrow bandwidth and the base station with a bandwidth other than the narrow bandwidth of the MTC device (for example, an MTC device with a bandwidth of 1.4 MHz and a base station with a bandwidth of 10 MHz).

Hereinafter, a procedure of allocating and transmitting/receiving a physical channel for the low-priced MTC device using a narrow bandwidth in a 3GPP LTE based mobile communication system according to the present invention will be described in detail with reference to the accompanying figures.

Downlink control channels and data channels for a legacy LTE user terminal, which are disclosed in the 3GPP LTE based wireless transmission specification, are as follows:
Legacy physical downlink shared channel (PDSCH): Physical channel for transmitting downlink data
Legacy physical downlink control channel (PDCCH): Physical channel for transmitting control information for demodulating PDSCH.
Legacy physical control format indicator channel (PCFICH): Physical channel for transmitting the number of OFDM symbols occupied by PDCCH
Secondary synchronization signal (SSS)/Primary synchronization signal (PSS): Synchronization channel
Physical Broadcast Channel (PBCH): Physical channel for transmitting system information such as a system bandwidth, etc

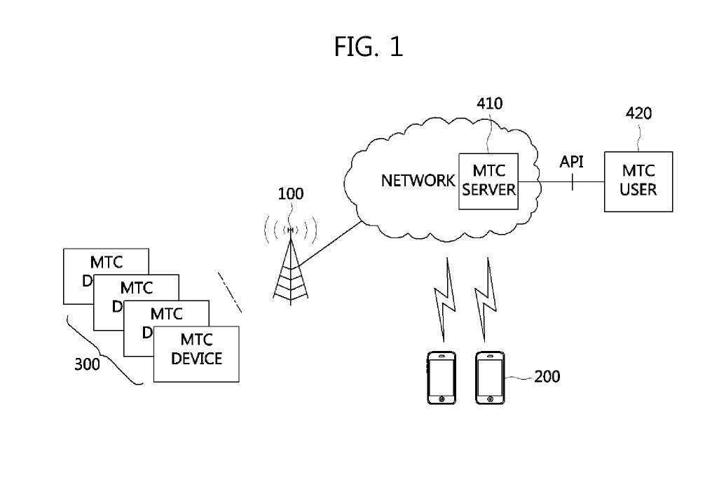

FIG. 1 is a concept view of a mobile communication network for providing MTC service according to the present invention.

As shown in FIG. 1, the mobile communication network for providing MTC service includes an MTC server 410, an MTC user 420, and at least one MTC device 300, which provides the MTC service, in addition to existing mobile communication network elements such as a base station 100, a user terminal 200, etc.

The MTC device 300 is a terminal having a MTC communication function for communicating through public land mobile network (PLMN) with an MTC server and other MTC devices.

The MTC server 410 communicates with PLMN, and communicates through PLMN with the MTC device 300. The MTC server 410 also has an interface accessible by an MTC user and provides service for the MTC user 420. The MTC user 420 uses the service provided by the MTC server 410.

In a configuration of FIG. 1, the MTC server 410 is controlled by a network operator. The network operator provides an application programming interface (API) on the MTC server. The MTC user 420 accesses the MTC server of the network operator through the API.

Although the MTC server is illustrated as being included in a network operator domain in FIG. 1, the MTC server may be located outside the network operator domain. In this case, the MTC server is not controlled by the network operator.

Also, the MTC device 300 communicates through the base station 100 with the MTC server 410 located on a network.

To provide the MTC service through the mobile communication system illustrated in FIG. 1, smooth cooperation is essential for wireless connection between the MTC device and the mobile communication system. Accordingly, characteristics, such as bandwidth characteristics, of the mobile communication system in cooperation with the MTC device will be described.

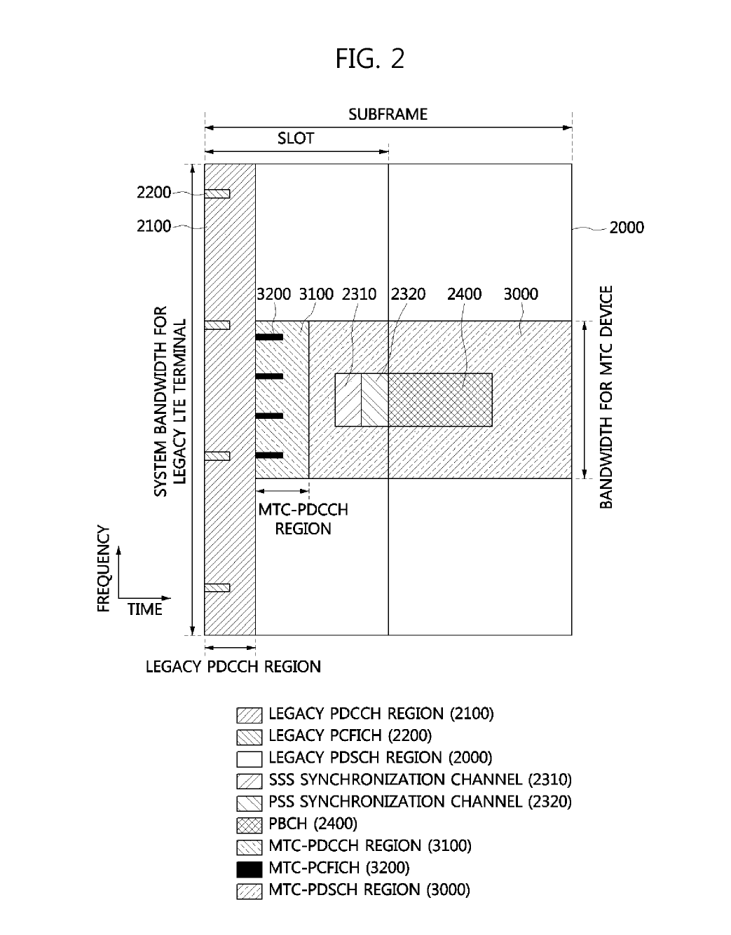

FIGS. 2 to 4 illustrate embodiments for allocating a control channel and a data channel according to the present invention.

That is, FIGS. 2 to 4 illustrate embodiments for allocating a control channel and a data channel for the MTC device according to the present invention while compatible with the legacy LTE terminal in a downlink subframe #0.

A frequency band occupied by physical channels of the MTC device may be located in the center of the frequency band for the legacy LTE user terminal. However, position of another frequency band other than the center of the legacy LTE frequency band does not depart from the spirit and scope of the invention.

As shown in FIGS. 2 to 4, a time-frequency region used by MTC downlink physical channels is included in a legacy PDSCH region used by a legacy LTE user terminal.

As shown in FIG. 2, the downlink control channel and data channel for the MTC device according to the present invention are defined as follows:
MTC-PDSCH: Physical channel for transmitting MTC downlink data
MTC-PDCCH: Physical channel for transmitting control information for demodulating MTC-PDSCH
MTC-PCFICH: Physical channel for transmitting the number of OFDM symbols (time domain) or resource blocks (RBs) (frequency domain) occupied by MTC-PDCCH

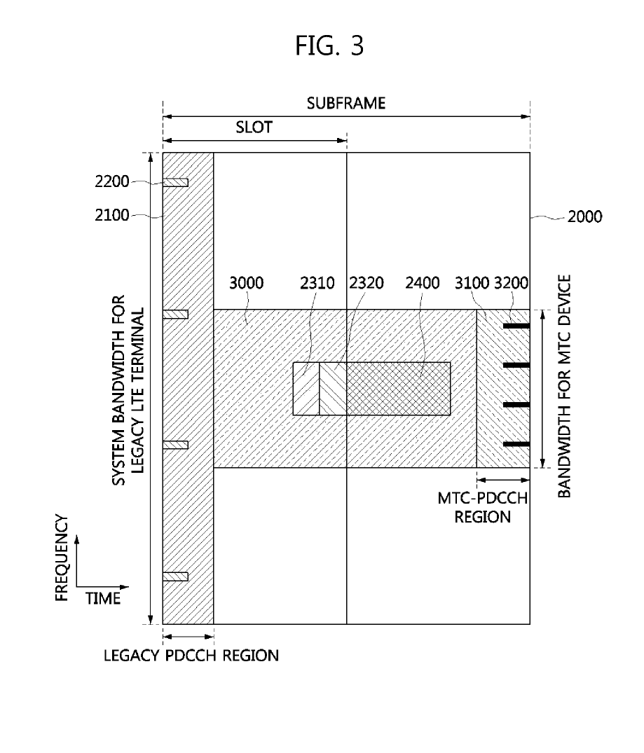

The MTC-PCFICH carries the number of the OFDM symbols occupied by the MTC-PDCCH region when the MTC-PDCCH region and MTC-PDSCH region for the MTC device are divided by time division multiplexing (TDM) as illustrated in FIGS. 2 and 3.

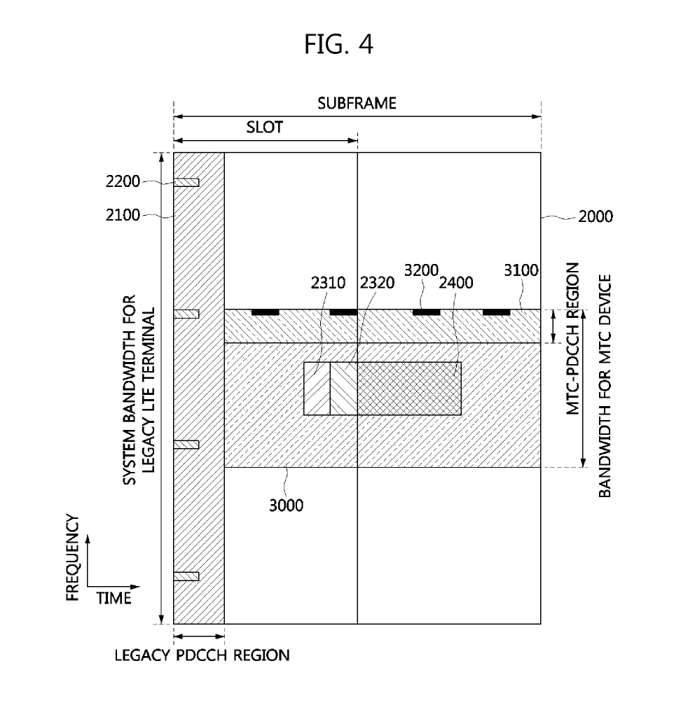

The MTC-PCFICH carries the number of subcarriers or RBs occupied by the MTC-PDCCH region when the MTC-PDCCH region and MTC-PDSCH region for the MTC device are divided by frequency division multiplexing (FDM) as illustrated in FIG. 4. Moreover, the number of groups is transmitted when several resource blocks or subcarriers are transmitted as a group.

According to an embodiment of the present invention, the MTC-PCFICH may carry information about the number of OFDM symbols occupied by the legacy PDCCH, which is carried by legacy PCFICH, in addition to information about the number of OFDM symbols occupied by MTC-PDCCH region (for example, see FIG. 3). It is also within the scope of the present invention that the MTC-PCFICH carries only the number of OFDM symbols occupied by a legacy PDCCH.

According to the present invention, information about a wireless resource region allocated for the MTC, particularly position of a first OFDM symbol of the MTC physical channel, may be extracted using several methods.

A first method of estimating the position of the first OFDM symbol of the MTC physical channel is to notify a terminal of a maximum number (N_{PDCCH}) of the OFDM symbols occupied by the legacy PDCCH on its cell through radio resource control (RRC) signaling, layer 1 (L1) signaling, or system information (SI). In this case, the legacy PDCCH occupies OFDM symbols from OFDM symbol number #0 to OFDM symbol number #N_{PDCCH}−1, and subsequently the MTC physical channels occupy resources from OFDM symbol number #N_{PDCCH}.

A second method of estimating the position of the first OFDM symbol of the MTC physical channel is, for example, as shown in FIG. 3, to transmit the number of OFDM symbols occupied by the legacy PDCCH channel, which are carried by the legacy PCFICH, through MTC-PCFICH or separate signaling.

A third method is to detect the number of OFDM symbols implicitly occupied by the legacy PDCCH channel through blind decoding. When the MTC device detects the number of OFDM symbols occupied by the PDCCH channel, the MTC device may derive a start position of a resource region for MTC occupying the next OFDM symbol.

In FIG. 2, the MTC-PDCCH region and MTC-PDSCH region are divided by TDM, and the MTC-PDCCH region is positioned in an OFDM symbol time earlier than that in the MTC-PDSCH region.

In FIG. 3, the MTC-PDCCH region and MTC-PDSCH region are divided by TDM, and the MTC-PDCCH region is positioned in an OFDM symbol time later than that in the MTC-PDSCH region. Alternatively, the MTC-PDCCH region may be positioned in a time region inside the MTC-PDSCH region.

In FIG. 4, the MTC-PDCCH region and MTC-PDSCH region are divided by FDM, and the MTC-PDCCH region is positioned in a frequency region higher than that in the MTC-PDSCH region. Alternatively, the MTC-PDCCH region may be positioned in a frequency region lower than that in the MTC-PDSCH region or in a frequency region inside the MTC-PDSCH region.

In FIGS. 2 to 4, methods used for legacy LTE physical channels may be used to map and modulate resources of MTC downlink physical channels. In this case, this method is based on a bandwidth for the MTC device, not a bandwidth for the legacy LTE terminal (for example, if the downlink bandwidth for the legacy LTE terminal is 10 MHz and the downlink bandwidth for the MTC device is 3 MHz, the method of mapping and modulating the resources of the MTC physical channels conforms to an LTE transmission specification for 3 MHz). In this case, as shown in FIGS. 2 to 4, OFDM symbol positions (time domain) used by the MTC physical channels are different from each other, and thus OFDM symbol positions are differently applied in the LTE transmission specification.

The MTC-PCFICH is in a first OFDM symbol of the MTC-PDCCH region in FIG. 2, in a last OFDM symbol of the MTC-PDCCH region in FIG. 3, and in a highest frequency region of the MTC-PDCCH region in FIG. 4. Alternatively, the MTC-PCFICH may be in another frequency-time region.

As shown in FIGS. 2 to 4, the MTC-PCHICH may be transmitted over an entire frequency band or time band used by the MTC device in order to obtain frequency diversity or time diversity effect.

According to whether the MTC-PCFICH is detected, it can be found whether the MTC-PDCCH of the MTC device may have been transmitted. If the MTC-PCFICH is not detected, the MTC physical channel region may be occupied by the legacy LTE terminal.

In embodiments of FIGS. 2 to 4, the position of the MTC-PDCCH region may be fixed.

If the MTC-PDCCH region is fixed and a first OFDM symbol position of the MTC physical channel may be known in a subframe (for example, if a first position is not fixed), the MTC-PCHICH may not be used.

In this case, it can be found through the detection of the MTC-PDCCH whether the MTC-PDSCH of the MTC device may have been transmitted. However, if the MTC-PCHICH carries the number of OFDM symbols occupied by the legacy PDCCH, the MTC-PCFICH cannot be omitted.

When the MTC physical channels are not transmitted in FIGS. 2 to 4, the MTC physical channel region may be occupied by the PDSCH for the legacy LTE terminal.

When the bandwidth for the legacy LTE terminal is less than the bandwidth for the MTC device, the physical channels are allocated such that the MTC transmission and reception bandwidth is fitted to the bandwidth for the legacy LTE terminal. For example, if the bandwidth for the legacy LTE terminal is 3 MHz and the bandwidth for the MTC is 5 MHz, the MTC device uses a bandwidth of 3 MHz.

If the MTC device supports an uplink hybrid ARQ (HARQ), the downlink MTC-PHICH carrying ACK/NACK information about the MTC uplink data channel (hereinafter, referred to as the MTC-PUSCH) may be transmitted. If the MTC device does not support the uplink HARQ, the transmission of the MTC-PHICH may be omitted.

The transmission and reception bandwidth of the MTC device is cell-specific or UE-specific. If the transmission and reception bandwidth of the MTC device is cell-specific, all MTC devices in a cell use the same transmission and reception bandwidth, and information about the transmission and reception bandwidth of the MTC device may be carried using reserved bits of a PBCH channel. The information may be informed through RRC signaling, L1 signaling, or system information. If the transmission and reception bandwidth is UE-specific, the transmission and reception bandwidth used by the MTC device may be informed through a signaling process (for example, a random access procedure) to a base station.

FIGS. 2 to 4 show allocation of a control channel and a data channel for the MTC device while the MTC device is compatible with the legacy LTE terminal in a downlink subframe #0. However, the MTC physical channels may not be carried in a subframe #0 or subframes #0 and #5 when the MTC device has a very small bandwidth (for example, 1.4 MHz).

Even when the downlink bandwidth for the legacy LTE terminal is less than or equal to the downlink bandwidth for the MTC device, as shown in FIGS. 2 to 4, time-frequency resources used by the MTC downlink physical channels is positioned after an OFDM symbol (time domain) occupied by the legacy PDCCH channel region. However, the MTC physical channels are allowed to be used from a first OFDM symbol position of a subframe, and thus the method of mapping and modulating resources of LTE transmission specification for legacy physical channels, which is fitted to the legacy LTE terminal, may be used. In this case, the legacy LTE terminal and the MTC device share all time-frequency resources of the subframe.

The present invention includes dividing the downlinks and/or uplinks of the legacy LTE terminal and MTC device by TDD in a subframe unit and allocating resources.

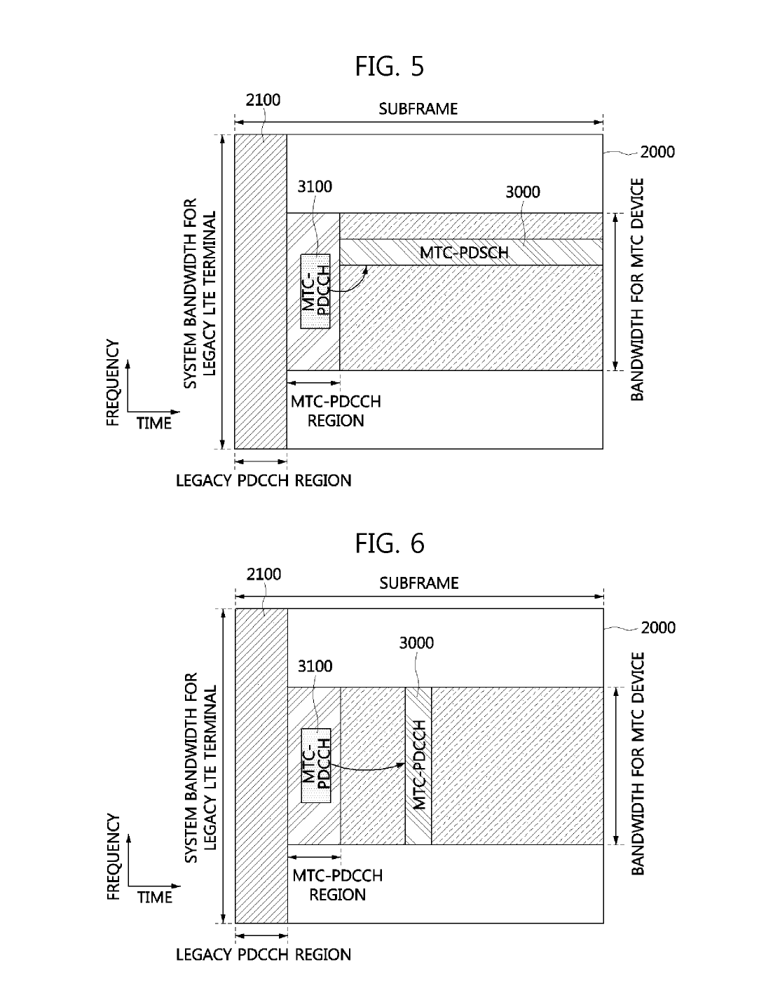

FIGS. 5 and 6 illustrate MTC-PDCCH indication for MTC-PDSCH demodulation using a method of allocating a physical channel according to an embodiment of the present invention as shown in FIG. 2.

FIG. 5 shows an embodiment where the MTC-PDSCH of each MTC device is divided by FDM. FIG. 6 shows an embodiment where the MTC-PDSCH of each MTC device is divided by TDM.

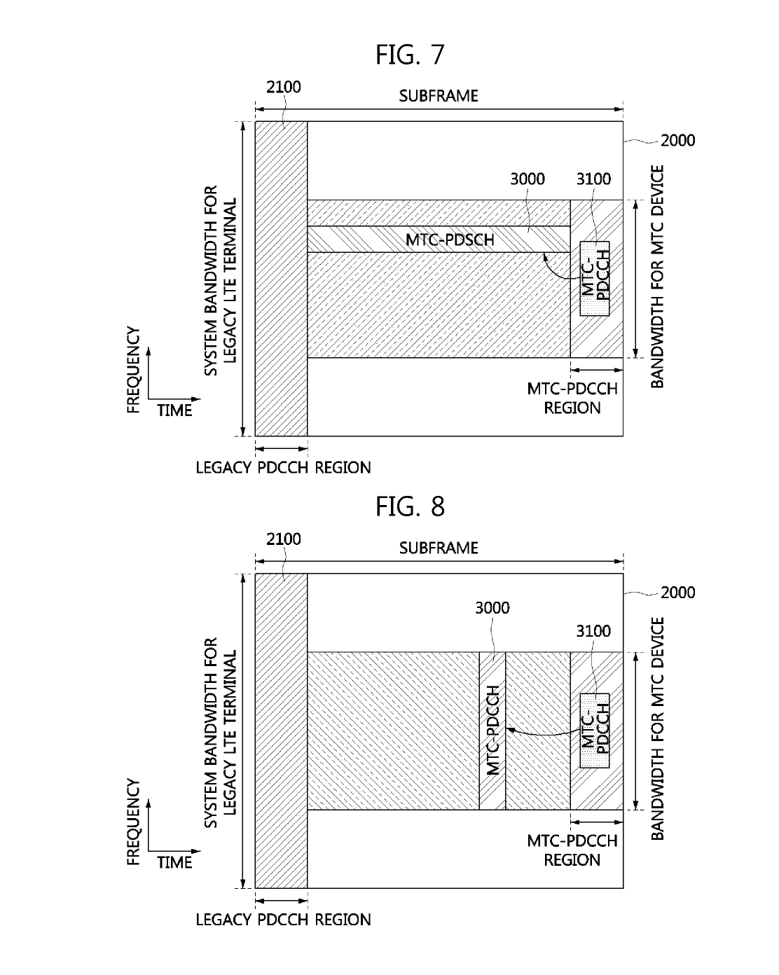

FIGS. 7 and 8 illustrate MTC-PDCCH indication for MTC-PDSCH demodulation using a method of allocating a physical channel according to an embodiment of the present invention as shown in FIG. 3.

FIG. 7 shows an embodiment where the MTC-PDSCH of each MTC device is divided by FDM. FIG. 8 shows an embodiment where the MTC-PDSCH of each MTC device is divided by TDM.

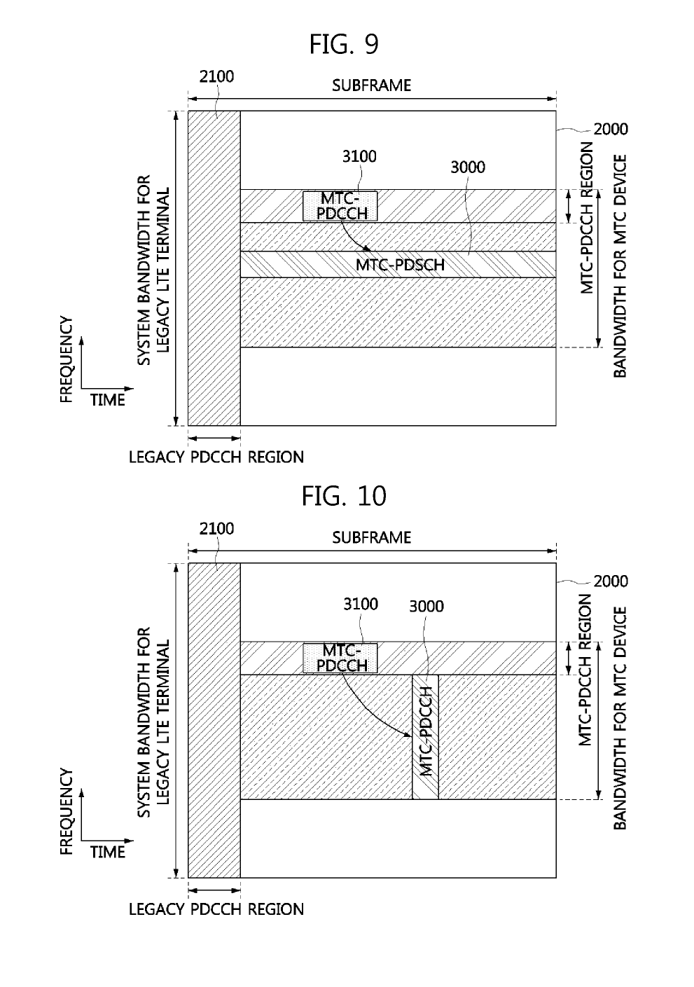

FIGS. 9 and 10 illustrate MTC-PDCCH indication for MTC-PDSCH demodulation using a method of allocating a physical channel according to an embodiment of the present invention as shown in FIG. 4.

FIG. 9 shows an embodiment where the MTC-PDSCH of each MTC device is divided by FDM. FIG. 10 shows an embodiment where the MTC-PDSCH of each MTC device is divided by TDM.

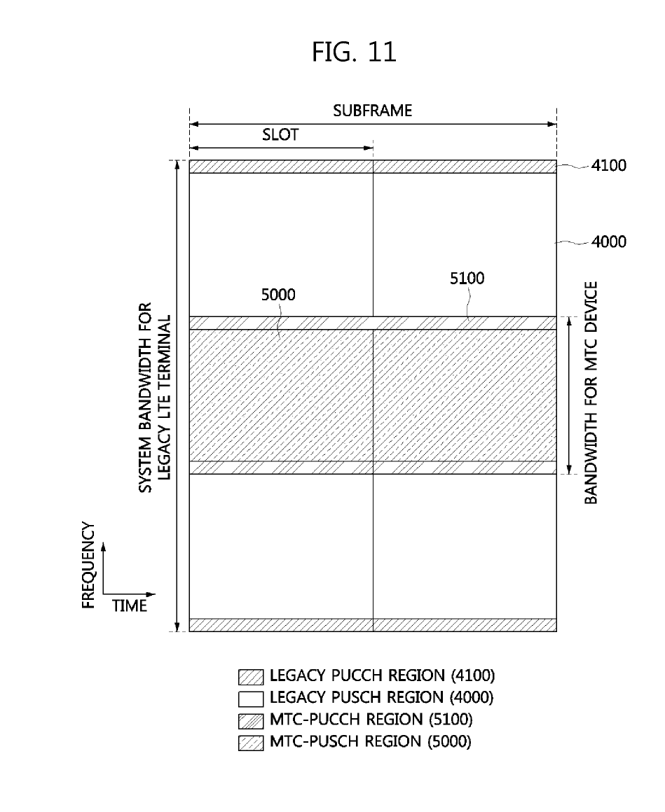

FIG. 11 is a concept view illustrating resource allocation in an MTC uplink according to an embodiment of the present invention.

That is, FIG. 11 illustrates an embodiment for allocating an uplink control channel and data channel for the MTC device according to the present invention while compatible with the legacy LTE user equipment in an uplink.

As shown in FIG. 11, a time-frequency region used by MTC uplink physical channels is included in a legacy PUSCH region used by the legacy LTE terminal. That is, the MTC uplink physical channels may use resources in a PUSCH region, and resources which are not used by the MTC uplink physical channels may be allocated by the legacy PUSCH channel.

As in the downlink, the uplink control channel and data channel for the MTC device according to the present invention are referred to as follows:
MTC-PUSCH: Physical channel for transmitting MTC uplink data
MTC-PUCCH: Physical channel for transmitting ACK/NACK information and measurement information about the MTC-PDSCH

In FIG. 11, the MTC-PDCCH region and MTC-PDSCH region are divided by FDM, and the MTC-PDCCH region is positioned in a top frequency region and a bottom frequency region of a bandwidth for the MTC device. However, embodiments of the present invention are not limited to this time-frequency region division. For example, the MTC-PUCCH region may be positioned in the center frequency region of a bandwidth for the MCT device for utility of legacy PUSCH allocation or MTC-PUSCH allocation.

As shown in FIG. 11, a frequency band occupied by the physical channels of the MTC device in an uplink is basically positioned to the center of a frequency band for the legacy LTE terminal. However, positioning of the frequency band occupied by the physical channels of the MTC device in an uplink to other frequency bands other than the center frequency band of the legacy LTE frequency band does not depart from the scope of the present invention. In this case, information about frequency band position may be transmitted and received through RRC signaling, L1 signaling, or system information.

In FIG. 11, methods used for legacy LTE physical channels may be used to map and modulate resources of MTC uplink physical channels. In this case, this method is based on the bandwidth for the MTC device, not the bandwidth for the legacy LTE terminal (for example, if the uplink bandwidth for the legacy LTE terminal is 10 MHz and the uplink bandwidth for the MTC device is 3 MHz, the method of mapping and modulating the resources of the MTC uplink physical channels conforms to an LTE transmission specification for 3 MHz).

If the MTC device does not support downlink HARQ, uplink transmission of ACK/NACK information for the MTC-PDSCH may be omitted. The MTC-PUSCH may serve as the MTC-PUCCH. In this case, the MTC-PUCCH may not be used.

If the uplink bandwidth for the legacy LTE terminal is equal to or less than the uplink bandwidth for the MTC device, the MTC uplink physical channels may be transmitted in a method of mapping and modulating resources for the legacy uplink physical channels of LTE transmission specification according to the bandwidth for the legacy LTE terminal. In this case, the legacy LTE terminal and the MTC device share all time-frequency resources of the subframe.

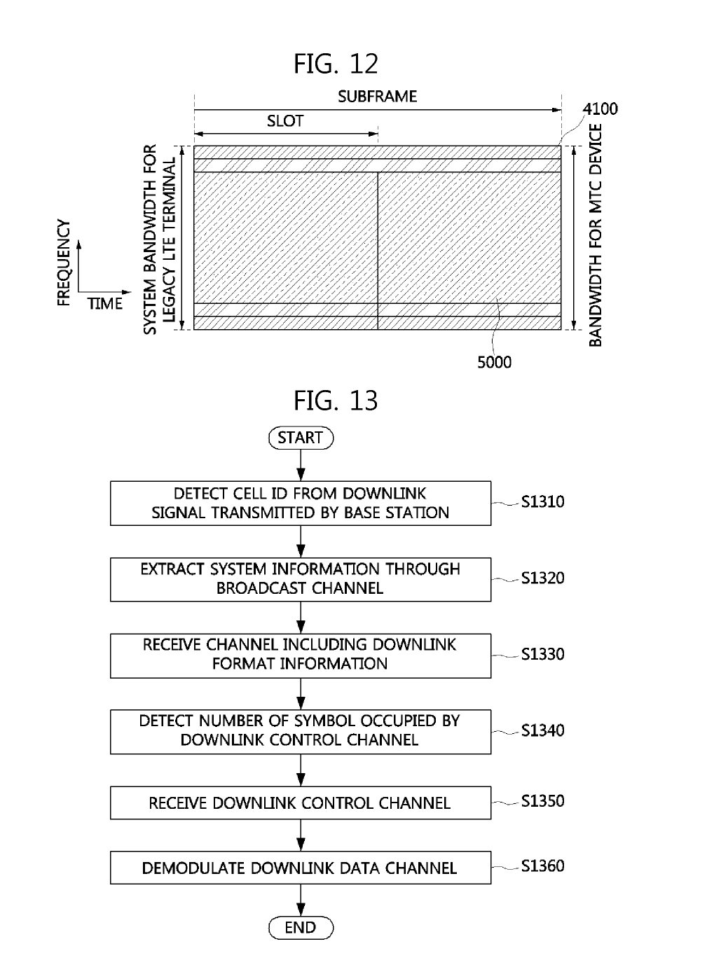

However, as shown in FIG. 12, positioning MTC uplink physical channels to resources which are inside a frequency region used by the legacy PUCCH channel, that is, the legacy PUSCH region is included in the scope of the present invention.

FIG. 12 is a concept view illustrating resource assignment in an MTC uplink according to another embodiment of the present invention.

If the MTC device uses only the MTC-PUSCH, not MTC-PUCCH, in an uplink, the MTC-PUCCH region is excluded in the FIGS. 11 and 12 and included in the MTC-PUSCH region. In FIGS. 11 and 12, the legacy PUSCH may be allocated to the MTC-PUSCH region.

FIG. 13 is a flowchart illustrating a method of transmitting and receiving data between a base station and a general legacy LTE terminal.

Referring to FIG. 13, the legacy LTE terminal detects a cell ID from a PSS/SSS synchronization channel (S1310), and receives a PBCH through channel estimation of cell-specific reference signal (CRS) using the cell ID, and extracts system information such as system bandwidth, etc (S1320). A terminal receives a channel including downlink control format information, for example, PCFICH according to the extracted system information (S1330), and detects the number of the OFDM symbols occupied by a downlink control channel (PDCCH) (S1340). The terminal receives the PDCCH (S1350) and demodulates a downlink data channel (PDSCH) (S1360).

When the PDCCH includes control information for uplink data channel (PUSCH) transmission, the control information may be extracted in step S1360, and a step of transmitting the PUSCH using the control information may be added.

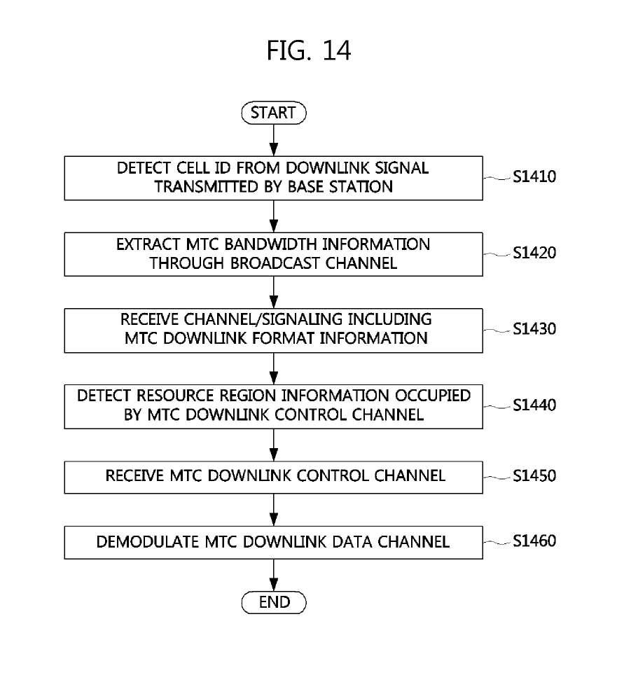

FIG. 14 is a flowchart illustrating a method of transmitting and receiving data between an eNodeB and an MTC device according to an embodiment of the present invention.

Specifically, FIG. 14 illustrates a method of transmitting and receiving data while the MTC device is compatible with the legacy LTE terminal in a 3GPP LTE based mobile communication system.

As illustrated in FIG. 14, the MTC device detects a cell ID from a PSS/SSS synchronization channel (S1410), and receives a PBCH through channel estimation of cell-specific reference signal (CRS) using the cell ID, and extracts information such as a MTC bandwidth, etc. in addition to a system bandwidth (S1420). In this case, the PBCH carries the MTC bandwidth in its reserved bits.

The MTC device receives a channel or signaling message including MTC downlink control format information, for example, MTC-PCFICH according to the detected system information (S1430).

When the MTC-PCFICH includes information about resource occupied by the legacy PDCCH, the number of OFDM symbols occupied by the legacy PDCCH through the MTC-PCFICH is detected. Alternatively, the number of OFDM symbols occupied by the legacy PDCCH may be obtained through separate signaling such as RRC signaling or L1 signaling, or through blind decoding. Also, as mentioned above, if the MTC-PDCCH region is fixed and a first OFDM symbol position of the MTC physical channel may be known in a subframe, step S1430 may be omitted.

The MTC device receives the MTC-PCFICH and detects resource region information occupied by the MTC downlink control channel (PDCCH) (S1440). Particularly, the MTC device detects the number of OFDM symbols (time domain) or resource blocks (RBs)/subcarriers/groups (frequency domain) occupied by the MTC-PDCCH.

The MTC device receives the MTC downlink control channel (MTC-PDCCH) (S1450) using the resource region information occupied by the MTC-PDCCH and demodulates the MTC downlink data channel (MTC-PDSCH) (S1460).

When the MTC-PDCCH includes control information for MTC uplink data channel (PUSCH) transmission, the control information may be extracted in step S1460, and a step of transmitting the PUSCH using the control information may be added.

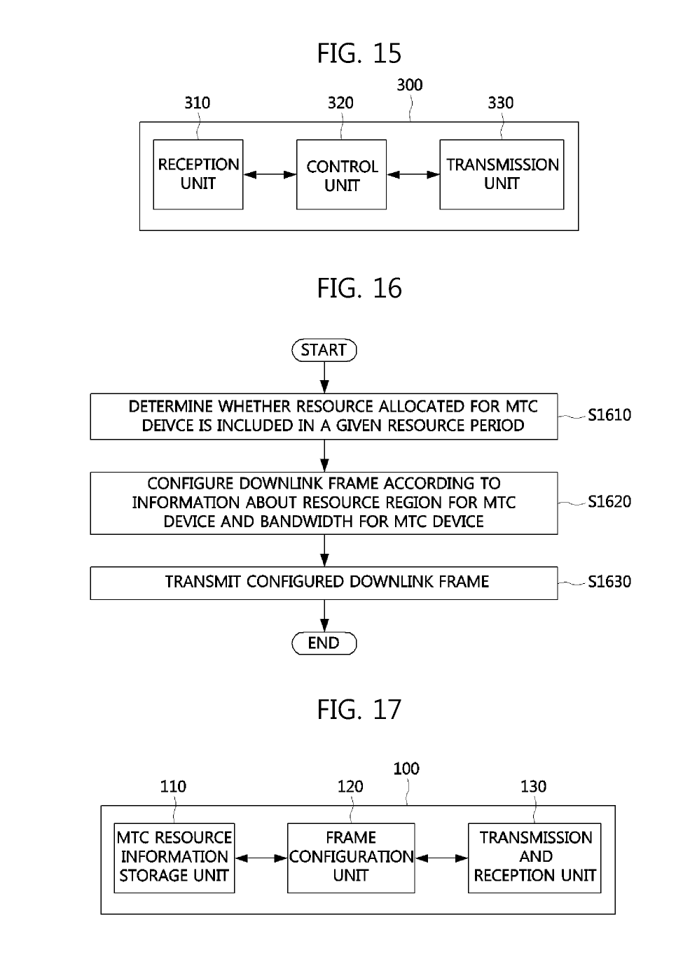

FIG. 15 is a block diagram showing an MTC device according to an embodiment of the present invention.

The MTC device according to the present invention may include a reception unit 310, a control unit 320, and a transmission unit 330.

First, the reception unit 310 receives at least one downlink channel or signaling from a base station.

The control unit 320 extracts MTC bandwidth information from the received downlink channel or signaling, detects an MTC downlink control channel, modulates an MTC downlink data channel using the MTC downlink control channel, and extracts control information for MTC uplink data transmission.

The transmission unit 330 transmits uplink data on the basis of the control information for the MTC uplink data transmission.

FIG. 16 is a flowchart illustrating a method of allocating resource according to an exemplary embodiment of the present invention.

The resource allocation method illustrated in FIG. 16 is mainly performed by the base station, and thus the following description will focus on the base station.

The base station determines whether resource allocated for the MTC device is in included in a given resource period in order to configure a downlink frame (S1610). When there is resource allocated for the MTC device, the downlink frame is configured according to the information about resource region and a bandwidth for the MTC device (S1620).

In this case, the information about the resource region for the MTC device includes a control channel and data channel for the MTC device and additionally may include an indicator for the control channel. Here, the information about a wireless resource period, where physical channels for legacy terminal are located, may be transmitted to the terminal as RRC signaling, L1 signaling, or system information. The information about a wireless resource period, where physical channels for legacy terminal are positioned, may also be transmitted through PCFICH for the MTC device. The information about the wireless resource period may not be transmitted by the base station. In this case, the MTC device may detect the number of symbols occupied by the legacy downlink control channel through blind decoding.

Finally, the base station transmits the configured downlink frame (S1630).

FIG. 17 is a block diagram showing a base station according to an embodiment of the present invention.

The base station 100 according to the present invention may include an MTC resource information storage unit 110, a frame configuration unit 120, and a transmission/reception unit 130.

The MTC resource information storage unit 110 stores resource information for MTC. Here, the resource information for MTC includes information about a control channel and data channel for the MTC device and a bandwidth for the MTC device, and may additionally store MTC downlink control format information.

The frame configuration unit 120 determines whether resource allocated for the MTC device is in included in a given resource period, for example one subframe. If there is resource allocated for the MTC device, the frame configuration unit 120 determines the class of the MTC device, determines the bandwidth of a resource region for the MTC device, and configures the downlink frame according to the bandwidth of the resource region for the MTC device.

The transmission/reception unit 130 transmits the downlink frame configured by the frame configuration unit 120 to at least one MTC device.

According to the present invention as described above, it is possible to perform channel allocation and transmission/reception for the low-priced MTC device in a 3GPP LTE based mobile communication system while keeping compatibility with legacy LTE user equipment.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A method of transmitting and receiving data in a machine type communication (MTC) device, the method comprising:
extracting MTC bandwidth information through a downlink channel or signaling;
receiving the downlink channel or signaling including MTC downlink control format information;
detecting resource region information occupied by an MTC downlink control channel; and
receiving the MTC downlink control channel using the resource region information occupied by the MTC downlink control channel,
wherein the resource region occupied by the MTC downlink control channel is positioned in the center of an entire system band on a frequency axis.

2. The method of claim 1, further comprising demodulating an MTC downlink data channel using the MTC downlink control channel.

3. The method of claim 1, wherein the downlink channel including the MTC downlink control format information further comprises downlink control format information for a user terminal.

4. The method of claim 2, wherein the MTC downlink control channel and the MTC downlink data channel are divided by frequency division multiplexing or time division multiplexing.

5. The method of claim 2, wherein the MTC downlink control channel and the MTC downlink data channel are included in a downlink data region for a user terminal.

6. The method of claim 1, wherein the downlink channel including the MTC downlink control format information is positioned in a first time region or a last time region of a downlink resource region for the MTC device, or in a top frequency region of the downlink resource region of the MTC device.

7. The method of claim 1, wherein the signaling including the MTC downlink control format information is radio resource control (RRC) signaling or layer 1 (L1) signaling.

8. The method of claim 1, further comprising:
when the MTC downlink control channel includes the control information for MTC uplink data transmission,
extracting control information for MTC uplink data transmission; and
transmitting MTC uplink data using an MTC uplink data channel and optionally an MTC uplink control channel.

9. The method of claim 8, wherein the MTC uplink data channel or the MTC uplink control channel is positioned within a downlink data region for a user terminal.

10. The method of claim 8, wherein the MTC uplink data channel and the MTC uplink control channel are divided by frequency division multiplexing.

11. The method of claim 8, wherein the MTC uplink data channel and the MTC uplink control channel occupy a top frequency region and a bottom frequency region of a bandwidth for the MTC device.

12. A machine type communication (MTC) device comprising:
a reception unit receiving at least one downlink channel or signaling;
a control unit detecting MTC bandwidth information and an MTC downlink control channel through the received downlink channel or signaling, demodulating an MTC downlink data channel using the MTC downlink control channel, and extracting control information for MTC uplink data transmission; and
a transmission unit transmitting uplink data on the basis of the control information for the MTC uplink data transmission, wherein the resource region occupied by the MTC downlink control channel is positioned in the center of an entire system band on a frequency axis.

13. The MTC device of claim 12, wherein the MTC downlink control channel and the MTC downlink data channel are divided by frequency division multiplexing or time division multiplexing.

14. A method of transmitting downlink data, the method comprising:
determining whether resource allocated for a machine type communication (MTC) device is included in a given resource period;
configuring a downlink frame according to information about a resource region for the MTC device and a bandwidth for the MTC device; and
transmitting the configured downlink frame to at least one MTC device, wherein the resource for the MTC device comprises a control channel and data channel for the MTC device and optionally an indicator for the control channel, and
wherein a resource region occupied by an MTC downlink control channel is positioned in the center of an entire system band on a frequency axis.
